(19) United States
(12) Patent Application Publication
(10) Pub. No.: US 2026/0295498 A1
(43) Pub. Date: Oct. 1, 2026

(54) STACKABLE SOLID SORBENT LAYERS FOR GAS SEPARATION AND METHOD OF MAKING

(71) Applicant: Mosaic Materials, Inc., Alameda, CA (US)

(72) Inventors: Marco Palladino, Calenzano (IT); David Madden, Limerick (IE); Alexander John Cruz, Mechelen (BE); Giulia Contran, Milano (IT); Chad Yates, Houston, TX (US); Rob Ameloot, Holsbeek (BE); Nicolas Chanut, Leuven (BE); Jesus Gandara Loe, Leuven (BE); Cesar Parra Cabrera, Kessel-Lo (BE)

(21) Appl. No.: 19/095,967

(22) Filed: Mar. 31, 2025

(51) Int. Cl. B01D 53/04; B01D 53/62

(52) U.S. Cl. CPC B01D 53/0407; B01D 53/62; B01D 2275/202

(57) ABSTRACT

An apparatus for removing a gas component from a gas mixture includes a plurality of solid sorbent layers stacked in series to provide a contactor assembly of solid sorbent layers receptive to the gas mixture and configured to reversibly adsorb at least a portion of the gas component from the gas mixture, each solid sorbent layer being traversed by at least one gas flow channel. A method for removing a gas component from a gas mixture includes obtaining a plurality of solid sorbent layers, each solid sorbent layer having a gas flow channel traversing the solid sorbent layer, stacking the plurality of solid sorbent layers in series to provide a contactor assembly of solid sorbent layers, and flowing the gas mixture through the contactor assembly of solid sorbent layers to remove the selected gas component from the gas mixture.

### BACKGROUND

Metal-organic-framework, which may be referred to as MOF, is a type of sorbent used to separate a selected gas from a mixture of gases. MOF is a family of materials with a porous structure providing a large surface area with which the mixture of gases can flow through and interact with the material to separate the selected gas. One useful application of MOF is to extract a greenhouse gas such as carbon dioxide (CO₂) for example from air or an effluent gas and thus contribute to reducing and mitigating the effects of climate change. Unfortunately, conventional pelletization processes used to manufacture MOFs have issues related to mechanical stability of the MOFs and other effects such as permeability and operationability, at large. Hence, it would be well received by industries making and/or using MOFs if new techniques were developed to use and manufacture MOFs with improved mechanical stability.

### BRIEF SUMMARY

Disclosed is an apparatus for removing a gas component from a gas mixture. The apparatus includes a plurality of solid sorbent layers stacked in series to provide a contactor assembly of solid sorbent layers receptive to the gas mixture and configured to reversibly adsorb at least a portion of the gas component from the gas mixture, each solid sorbent layer being traversed by at least one gas flow channel.

Also disclosed is a method for removing a gas component from a gas mixture. The method includes obtaining a plurality of solid sorbent layers, each solid sorbent layer having a gas flow channel traversing the solid sorbent layer, stacking the plurality of solid sorbent layers in series to provide a contactor assembly of solid sorbent layers, and flowing the gas mixture through the contactor assembly of solid sorbent layers to remove the selected gas component from the gas mixture.

Further disclosed is a method for fabricating a monolithic layer of solid sorbent. The method includes obtaining a mold having a desired outer shape, the mold having one or more channel formers, filling the mold with solid sorbent material using a blend melting process, and removing the solid sorbent material from the mold after it solidifies to provide the monolithic layer of solid sorbent.

### BRIEF DESCRIPTION OF THE DRAWINGS

The following descriptions should not be considered limiting in any way. With reference to the accompanying drawings, like elements are numbered alike:

FIG. 1 is a cross-sectional view of an embodiment of a gas component removal system having a contactor assembly using layers of solid sorbent;

FIGS. 2A and 2B, collectively referred to as FIG. 2, depict aspects of the layers of solid sorbent;

FIG. 3 depicts aspects of a housing in the system for supporting and aligning the layers of solid sorbent;

FIG. 4 depicts aspects of a mold for manufacturing a single layer of the MOF;

FIG. 5 is a flow chart for a method for removing a selected gas component from a gas mixture;

FIG. 6 depicts aspects of two contactor assemblies being in parallel; and

FIG. 7 is a flow chart for a method for manufacturing a monolithic layer of solid sorbent.

### DETAILED DESCRIPTION

A detailed description of one or more embodiments of the disclosed apparatus and method presented herein by way of exemplification and not limitation with reference to the figures.

Disclosed are stackable layers of a solid sorbent such as metal-organic-framework (MOF) for separating a gas from a mixture of gases. In one or more embodiments, the separated gas is carbon dioxide (CO₂) although the solid sorbent material can be selected to adsorb other gases. For teaching purposes, CO₂ is discussed as the gas component being removed, however, the solid sorbent layers may be configured to remove other gas components separately from CO₂ or in addition to CO₂. For example, gas components such as nitrous oxides (NOX) and sulfur oxides (SOX), which may be damaging to MOF-based CO₂ adsorber layers may be removed before reaching the MOF-based CO₂ adsorber layers. A selected number of layers can be stacked in an assembly to achieve a desired amount of gas separation capability for a selected amount of gas flow, such as a selected volumetric flow rate for example, for a particular application. The stackable layers can achieve cost savings by using a standardized design for various gas separation performance levels, thus eliminating the need for customized solid sorbent or MOF designs for each of various applications. Also disclosed are methods for fabricating a solid sorbent or MOF layer. In general, a mold is obtained for casting a disc or layer of a solid sorbent or MOF material using a blend melting process for blend melting a polymeric mixture. The mold generally includes multiple vertical or nearly vertical elements that extend from a bottom of the mold to a top of the mold. The vertical elements form gas flow channels that extend from one side of the layer to an opposing side of the layer being cast. The blend melt process provides a monolithic layer of solid sorbent or MOF that has the necessary structural integrity for multiple layers being stacked.

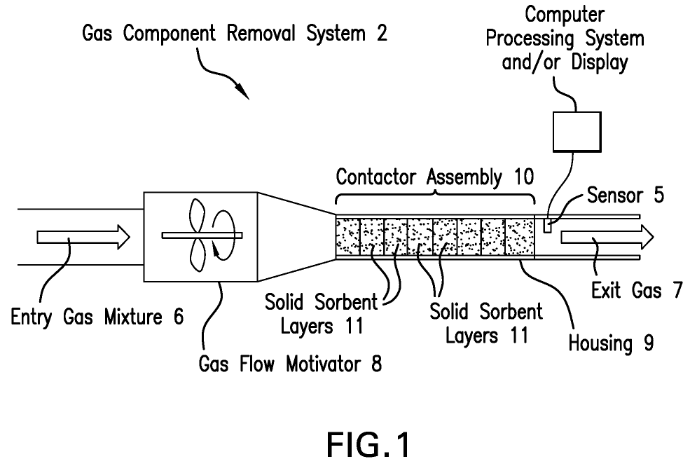

FIG. 1 illustrates a cross-sectional view of a gas component removal system 2 for removing a selected gas component from a gas mixture. In one or more embodiments, the gas component removal system 2 is a Direct Air Capture (DAC) system configured to remove carbon dioxide (CO₂) from air. In an alternative embodiment, the gas component removal system 10 is a point-source gas component removal system that is configured to remove a gas component from a point-source such as a discharge of a flue gas. The gas removal system 2 includes a contactor assembly 10 having a plurality of solid sorbent layers 11 disposed in a series arrangement. In one or more embodiments, one or more of the solid sorbent layers 11 is a MOF. Alternatively, or in addition to the MOF, the solid sorbent layers 11 may be made of other materials. The solid sorbent layers 11 are stacked in a housing 9, which provides a structure for assembling the stacked solid sorbent layers 11 in series together to form the contactor assembly 10. The housing 9 may also be configured to direct gas flow though the contactor assembly 10 such as by interfacing with duct work providing the gas flow. A gas flow motivator 8, such as a blower or fan in a duct, may be used to force an input gas mixture 6 to flow through the contactor assembly 10. An exit gas 7 exits the contactor assembly 10 and does not include or has a decreased concentration of a gas of interest separated by the contactor assembly 10.

A sensor 5 may be disposed at one or more points along a gas flow path to sense a parameter of interest. Non-limiting embodiments of the parameter of interest include flow rate, temperature, humidity, pressure, and/or chemical concentration (i.e., concentration of one or more selected gas components). The flow rate may be used to optimize the gas flow rate for the efficient use of the contactor assembly 10. Gas component concentration may be used to measure the efficiency of gas separation. Each sensor may provide readings to a computer processing system and/or an indicator display. The computer processing system may be configured to analyze or control operational aspects of the gas component removal system 2.

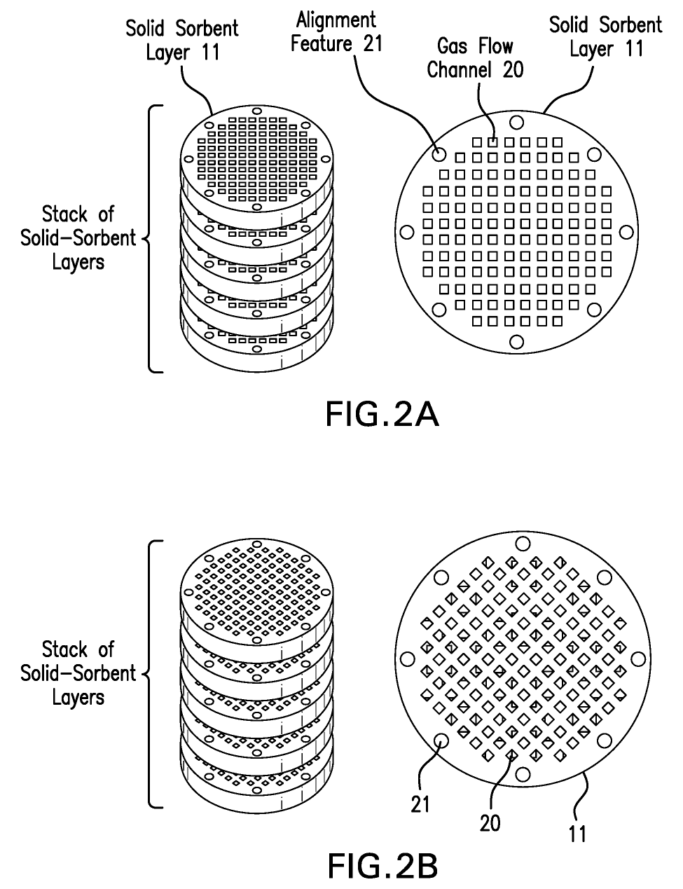

FIG. 2 depicts aspects of the solid sorbent layers 11. FIG. 2A illustrates a perspective view of an embodiment of a stack or series of the solid sorbent layers 11 (on left side) and a top view of a single solid sorbent layer 11 (on right side) in the stack of the layers 11 that is used in the contactor assembly 10. FIG. 2B illustrates a perspective view of another embodiment of a stack or series of the solid sorbent layers 11 (on left side) and a top view of a single solid sorbent layer 11 (on right side) in the stack of the layers 11 that is used in the contactor assembly 10. In the non-limiting embodiment of FIG. 2, the solid sorbent layers 11 are shaped as a disc. The solid sorbent layers 11 may have different shapes such as a square block, a rectangular block, a hexagonal block, or an octagonal block in nonlimiting embodiments. The solid sorbent layer 11 includes a gas flow channel or channels 20 for directing gas flow through the solid sorbent layer 11. The gas flow channels 20 increase the cross-sectional area exposed to the flow of gas to increase adsorption of the gas to be separated. The cross-sectional shape of the gas flow channels 20 can be circular or some other shape. The cross-sectional area of each of the channels 20 can be selected to balance the flow rate of the gas with an amount of solid sorbent or MOF material needed to adsorb a selected amount of gas to be separated over time.

Still referring to FIG. 2, each solid sorbent layer 11 includes an alignment feature 21. The alignment feature 21 keeps each solid sorbent layer 11 in rotational alignment about a longitudinal axis of the housing 9. In one or more embodiments, the alignment feature 21 is an alignment channel similar to the channel 20 for receiving a rod coupled to the housing 9. The rod keeps the solid sorbent layer 11 rotationally fixed in the housing 9. In one or more embodiments, the alignment feature 21 can be a notch that interfaces with a protrusion in the housing 9. Other types of alignment features may also be used.

In embodiments where the outer shape of each solid sorbent layer 11 has rotational symmetry, one solid sorbent layer 11 can be rotated with respect to another solid sorbent layer 11 that can be adjacent to the rotated solid sorbent layer 11 or further away from the rotated solid sorbent layer 11 by one or more interceding solid sorbent layers 11. Further, the rotational motion may also differ from one solid sorbent layer 11 to another solid sorbent layer 11. Each solid sorbent layer 11 that is disc shaped can be rotated in an infinite number of rotational positions. Each solid sorbent layer 11 that has an external hexagonal shape can be rotated in 60° increments while each solid sorbent layer 11 that has an external octagonal shape can be rotated in 45° increments. Other rotationally symmetric shapes may also be used. It can be appreciated that rotating one solid sorbent layer 11 with respect to another solid sorbent layer 11 can increase or decrease a tortuous path through the channels 20 to optimize gas adsorption for the input gas mixture at a given pressure such as established by the gas motivator 8 for example. This scenario also enhances heat and mass transport simultaneously, inducing a higher system-level capture or separation efficiency. A path or paths through the channels 20 can be optimized using a gas sensor (e.g., the sensor 5) disposed at a discharge of the housing 9 where the gas sensor senses a percentage of the gas to be separated in a gas mixture. It is assumed that the percentage of the gas to be separated is known at an entry point of the housing 9. If not, then another gas sensor can be disposed at the entry point to provide a starting reference point. With the gas motivator 8 on, one of the solid sorbent layers 11 can then be rotated with respect to another solid sorbent layer 11 without the rotated solid sorbent layer 11 being locked in place by the alignment feature 21 while the percentage of gas to be separated is measured by the discharge gas sensor. The optimized amount of rotation can then be determined based on a lowest reading of the discharge gas sensor or within a selected range about the lowest reading.

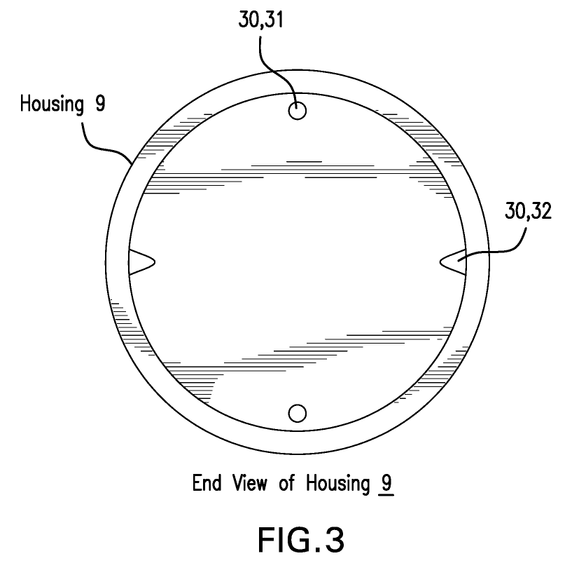

FIG. 3 illustrates an end view of the housing 9 demonstrating various embodiments of an alignment interface 30 that coordinates with the alignment feature 21 of each solid sorbent layer 11. In one embodiment, the alignment interface 30 is a rod 31 that interfaces with an alignment channel in each solid sorbent layer 11. In another embodiment, the alignment interface 30 is a protrusion 32 that interfaces with a notch in a perimeter of each solid sorbent layer 11. The rod 31 and the protrusion 32 can have any selected cross-sectional shape such as a round, rectangular or triangular shape for example.

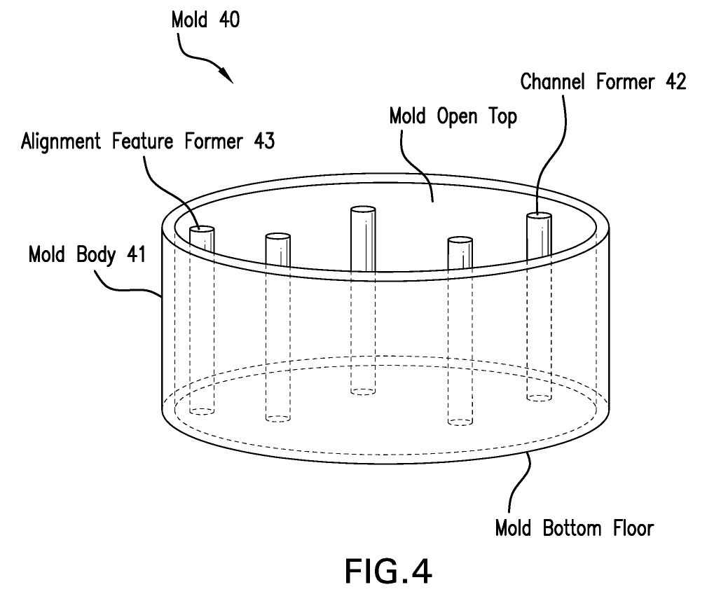

FIG. 4 depicts aspects of a mold 40 for forming one solid sorbent layer 11. The mold 40 includes a body 41 having a bottom floor and an open top side. The body 41 can be a single continuous curved side in embodiments where the solid sorbent layer 11 is shaped as a disc or can have four sides in embodiments where the solid sorbent layer is shaped as a square or a rectangle. The solid sorbent layer 11 can also have other shapes. A polymeric mixture can be poured into the open top side of the mold 40. The mold 40 may also include one or more channel formers 42, such as rods, which extend from the bottom floor to the open top side. The rods can have a cross-sectional shape that is circular, square or some other selected shape. The channel formers 42 form the gas flow channels 20 in the material in the mold 40 and thus go through the solid sorbent layer 11 once the solid sorbent layer 11 is removed from the mold 40. The mold 40 may also include one or more alignment feature formers 43 that form the alignment features 21 that interface with the alignment interfaces 30. The alignment feature formers 43 also may extend from the bottom floor to the open top side of the mold 40. The alignment feature formers 43 form the alignment features 21 in the material in the mold 40 and thus through the solid sorbent layer 11 once the solid sorbent layer 11 is removed from the mold 40. In one or more embodiments, the one or more alignment feature formers 43 are a rod for forming a channel and/or a protrusion for forming a notch. It can be appreciated that the mold 40 itself can be fabricated by additive manufacturing using a three-dimensional printer. Alternatively, the mold 40 can be fabricated using a subtractive manufacturing process such as machining for example.

In one or more embodiments, the solid sorbent layers 11 have a monolithic structure that provides the needed high structural integrity to be stackable for use in DAC applications. In general, a blend melting process using a polymeric mixture is used to form the solid sorbent layers 11 in the mold 40. The blend melting process results in each solid sorbent layer 11 having a monolithic structure. In one or more embodiments, the solid sorbent layer 11 includes MOF as the sorbent and the blend melting process includes mixing the MOF sorbent with a binder, such as a polymer, in a solvent to form a blend melt mixture. The blend melting process then includes pouring the blend melt mixture into a mold where it solidifies and can then be removed from the mold. In one or more embodiments, the concentration of MOF sorbent in the mixture or formulation is 50% - 80% %-wt (mass) with the complementary being the binder.

In one or more embodiments, suitable solvents include low boiling points solvents of polar and non-polar nature, alkanes, aromatics, and others including, but not limited to acetone, acetonitrile, dimethylformamide (DMF), dimethylsulfoxide (DMSO), methanol, ethanol, or isopropanol.

In one or more embodiments, the MOF sorbent is an amine functionalized MOF material. The MOF material can include inorganic nodes connected by organic linkers. The inorganic nodes may include metal sites, which can be ions of least one of Mg, Ca, Ba, Al, Sc, Zr, V, Cr, Mn, Fe, Co, Ni, Cu, Zn, Ti, Cd, or Eu. In one or more embodiments, the ions are at least one of Mg, Mn, Zn, or Ni. The organic linkers can include at least one of a carboxylate, a triazolate, or an imidazolate. In one or more embodiments, the organic linker is a carboxylate. Examples of the organic linkers include, but are not limited to 4,4’-dihydroxy-(1,1-biphenyl)-3,3’-dicarboxylate, 2,5-dihydroxybenzene-1,4-dicarboxylate, 4,6-dihydroxybenzene-1,3-dicarboxylate, benzene-1,4-dicarboxylate, benzene-1,3,5-tricarboxylate, 3,3’,4,4’-benzophenone-tetracarboxylate, benzene-1,2,4,5-tetracarboxylate, trans-1,4-cyclohexanedicarboxylate, 1H,7H-[1,4]dioxino[2,3-F:5,6-F’]bisbenzotriazolate, 1,5-dihydrobenzo[1,2-d:4,5-d’]bis([1,2,3]triazolate), 3,5-dimethyl-1H-pyrazole-4-carboxylate, 5-(pyridin-3-yl)benzene-1,3-dicarboxylate, 1,3,5-tri(1H-tetrazol-5-yl) benzene, 2-methylimidazolate, 2-ethylimidazolate, and 1-benzyl-1H-imidazolate. Other suitable known organic linkers can also be used. In one or more embodiments, the organic linkers include 4,4’-dihydroxy-(1,1-biphenyl)-3,3’-dicarboxylate. Examples of MOF materials can include, but are not limited to, MOF-74, MOF-274, HKUST-1, MIl-100, MIL-101, MOF-525, MOF-2, MOF-505, and UiO-66. Additional MOF materials include but are not limited to those described in Chem. Soc. Rev. 2020, 49, 2751-2798. In one or more embodiments, the MOF material is Mg2(dobpdc) where the inorganic nodes include Mg ions and the organic linkers include 4,4’-dihydroxy-(1,1’-biphenyl)-3,3’-dicarboxylate (dobpdc). 30. The amine can be: a monoamine; a diamine such as a primary/primary diamine, a primary/secondary diamine, a primary/tertiary diamine, and a secondary/secondary diamine; a polyamine such as a triamine, a tetramine, and an aminopolymer; or a bifunctional amine. The monoamines can be monoalkylamines, dialkylamines, trialkylamines, monoarylamines, diarylamines, triarylamines, and mixed alkyl-aryl-amines. Examples of the monoamines include, but are not limited to, aniline, n-butylamine, n-pentylamine, n-hexylamine, diphenylamine, and triethylamine. Examples of the diamines include, but are not limited to, ethylene diamine, 2,2-dimethyl-1,3-propanediamine, 1,3-diaminopentane, 2-methylpropane-1,2-diamine, N-ethylethylenediamine, N-isopropylethylenediamine, N-butylethylenediamine, N-pentylethylenediamine, N-hexylethylenediamine, N,N-dimethylethane-1,2-diamine, N,N-diethylethylenediamine, N,N-diisopropylethylene diamine, N,N-dimethylpropylenediamine, N,N’-dimethylethane-1,2-diamine, 2-(aminomethyl)piperidine, and N,N-diethyl-N-methylethylenediamine. Suitable polyamines include, but are not limited to, bis(3-aminopropyl)amine, N,N’-bis(3-aminopropyl)-1,4-butanediamine, tetraethylene pentaamine, polyethyleneimine, and polypropyleneimine. In one or more embodiments, the amine includes a primary/secondary diamine. As used herein, a bifunctional amine refers to an amine having an additional functional group other than an amino group. Examples of the bifunctional amines include, but are not limited to, amino-alcohols (also known as alkanolamines).

In one or more embodiments, the binder includes at least one of a cellulose polymer, starch, a siloxane polymer, a cellulose-siloxane polymer, polyvinyl pyrrolidone, polyvinyl alcohol, poly (ethyl vinyl acetate), polyacrylate, polymethacrylate, polyvinylpyrrolidone, polyisobutene, a polyurethane, a biopolymer, acrylate polymers, such as PMMA, polyacrylate, polymethacrylate, PVDF, or PTFE.

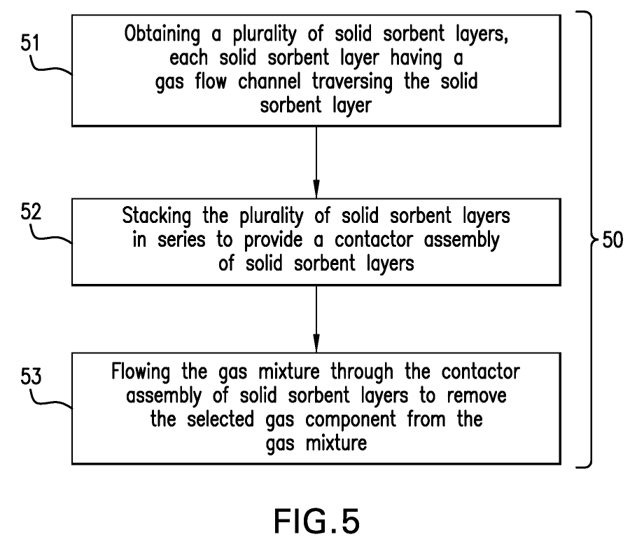

FIG. 5 is a flow chart for a method 50 for removing a selected gas component from a gas mixture. Block 51 calls for obtaining a plurality of solid sorbent layers, each solid sorbent layer having a gas flow channel traversing the solid sorbent layer. In one or more embodiments, each solid sorbent layer is substantially the same as the other solid sorbent layers. The term “substantially” is intended to mean that there may be slight differences that do not significantly affect the relative performance of solid sorbent layers for removing the selected gas component. Alternatively, at least one solid sorbent layer in the plurality of solid sorbent layers can have a different composition from another solid sorbent layer in the plurality of solid sorbent layers. As discussed further above, different solid sorbent layers can have different compositions to remove other gas components that may interfere with removal of the gas component of interest. In this way, compositions of various solid sorbent layers can be optimized based on performance or function of previous solid sorbent layers in the stack and provide cascading effects. In one or more embodiments, each solid sorbent layer includes an alignment feature that provides for aligning each solid sorbent layer in a selected orientation. In one or more embodiments, each solid sorbent layer has a rotational symmetry about an axis traversing a center of each solid sorbent layer. In one or more embodiments, each solid sorbent layer is disc shaped, square shaped, hexagonal shaped, octagonal shaped, or some other selected shape.

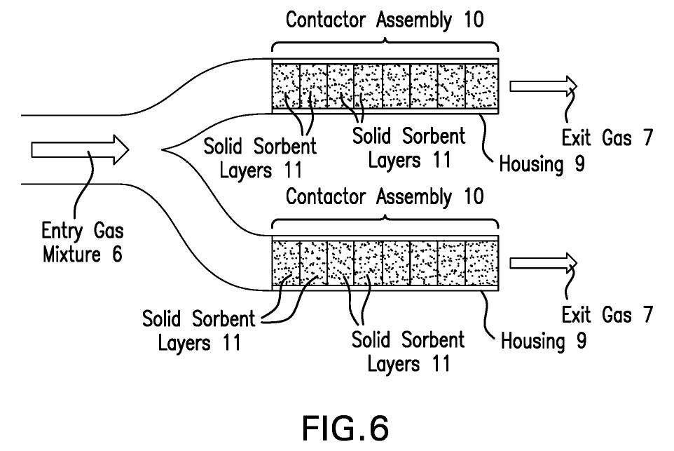

Block 52 calls for stacking the plurality of solid sorbent layers in series to provide a contactor assembly of solid sorbent layers. The solid sorbent layers may be stacked in a housing that provides structural integrity to the stack of solid sorbent layers. Each solid sorbent layer may include an alignment feature and the housing may include an alignment interface that interfaces with the alignment feature of each solid sorbent layer to secure the solid sorbent layers in a selected rotational orientation. In one or more embodiments, multiple housings each having a stack of solid sorbent layers may be disposed in parallel (see FIG. 6) to increase the amount or rate of gas being removed.

Block 53 calls for flowing the gas mixture through the contactor assembly of solid sorbent layers to remove the selected gas component from the gas mixture. In one or more embodiments, the selected gas component is carbon dioxide and the gas mixture is air or a gas combustion product. In one or more embodiments, the gas mixture is a gaseous fuel such as but not limited to hydrogen, ammonia, methanol, natural gas, high hydrocarbon chains, and their mixtures (and impurities).

The method 50 may also include rotating at least one of the solid sorbent layers in the assembly of solid sorbent layers with respect to another solid sorbent layer to adjust an amount or rate of gas capture such as to maximize the amount or rate. In one or more embodiments, a sensor, such as the sensor 5 illustrated in FIG. 1, can be located in a discharge of the gas removal system 2 and configured to sense a concentration of the gas being removed. Hence, an output of the sensor can provide feedback to determine an optimized orientation of the solid sorbent layer being rotated.

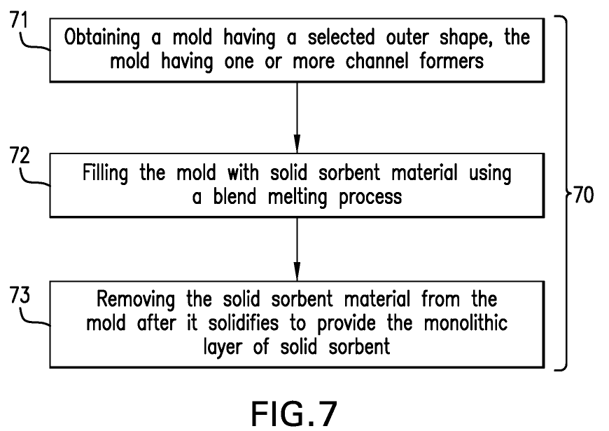

FIG. 7 is a flowchart for a method 70 for fabricating a monolithic layer of a solid sorbent. Block 71 calls for obtaining a mold having a selected outer shape, the mold having one or more channel formers. In one or more embodiments, the outer shape has rotational symmetry such as a circle, a hexagon, or an octagon for example. Other shapes may also be used. In general, the channel formers extend from a bottom floor of the mold up to an open topside of the mold. The mold may also include one or more alignment feature formers. The mold can be metallic or polymeric and can be manufactured using additive manufacturing, subtractive manufacturing, or casting.

Block 72 calls for filling the mold with solid sorbent material using a blend melting process. In general, the solid sorbent material such as MOF material is poured into the mold from an open topside although there may be other ways such as through dedicated ports penetrating a body of the mold. In one or more embodiments, the MOF material used in the blend melting process is in powder form. In one or more embodiments, single components including MOF are mixed together to form a mixture and the mixture is poured in the mold. The mold and thus the mixture is processed by acting on different physical quantities (e.g. pressure and/or temperature) for a pre-defined duration of time. In non-limiting embodiments, the blend melt composition is made of a mixture of a solid sorbent, a polymer or a binder, and a solvent. Examples of solid sorbent include amine-functionalized solid sorbents, amine-appended MOFs, amine-impregnated solids, zeolites, mesoporous silicas, and metal-organic-framework adsorbents. Non-limiting embodiments of polymers include aminosilanes, aminoalkylated polymers, polystyrene, acrylate-based polymer. Other components such as crosslinkers or solvents may also be used.

Block 73 calls for removing the solid sorbent material from the mold after it solidifies to provide the monolithic layer of solid sorbent.

The stacked layers of solid sorbent provide several advantages. One advantage is that different size contactor assemblies (i.e., having different adsorption capabilities) can be built with just one mold, thus avoiding investment in several different molds. Another advantage is that different size contactors can be built by just stacking a selected number of layers of solid sorbent. Yet another advantage is that by changing an alignment angle, the tortuosity of the gas flow channels can be modified resulting in mass-transfer and heat rates being enhanced by modifying the flow path. Yet another advantage is that by using a blend melting process, each layer of solid sorbent can have high mechanical stability for enabling the stacking of layers. Yet another advantage is that after the stacked layers adsorb an amount of the removed gas component, the stacked layers considered as being full or near full can be removed and replaced with fresh stacked layers to keep the gas removal process going. The stacked layers that are removed can then undergo a regeneration process so that they can be used again. In some embodiments having parallel housings or paths, one path can be isolated from service to replace the stacked layers, while the other path continues to adsorb the gas component. The path being removed from service can be isolated by closing dampers or valves that isolate the path. Yet another advantage is that different solid sorbent layers can have different material compositions to provide adsorption of multiple selected gas components in a selected sequence or selected cascading effects. In one example, materials other than MOF can be used together with MOF in a layer composition.

In support of the teachings herein, various analysis components may be used, including a digital and/or an analog system. For example, the sensor 5, the computer processing system, and any supporting system may include digital and/or analog systems. The system may have components such as a processor, storage media, memory, input, output, communications link (wired, wireless, optical or other), user interfaces (e.g., a display or printer), software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Set forth below are some embodiments of the foregoing disclosure:
Embodiment 1: An apparatus for removing a gas component from a gas mixture, the apparatus comprising a plurality of solid sorbent layers stacked in series to provide a contactor assembly of solid sorbent layers receptive to the gas mixture and configured to reversibly adsorb at least a portion of the gas component from the gas mixture, each solid sorbent layer being traversed by at least one gas flow channel.
Embodiment 2: The apparatus according to any prior embodiment, wherein at least one solid sorbent layer in the plurality of solid sorbent layers has a different composition from another solid sorbent layer in the plurality of solid sorbent layers.
Embodiment 3: The apparatus according to any prior embodiment, wherein each of the solid sorbent layers are substantially the same.
Embodiment 4: The apparatus according to any prior embodiment, wherein each solid sorbent layer comprises an alignment feature configured to align each solid sorbent layer in a selected rotational orientation.
Embodiment 5: The apparatus according to any prior embodiment, wherein the plurality of solid sorbent layers is disposed in a housing.
Embodiment 6: The apparatus according to any prior embodiment, wherein the housing comprises an alignment interface configured to interface with the alignment feature of each solid sorbent layer.
Embodiment 7: The apparatus according to any prior embodiment, wherein the alignment interface comprises at least one of a rod or a protrusion.
Embodiment 8: The apparatus according to any prior embodiment, wherein each solid sorbent layer comprises a shape of a disc.
Embodiment 9: The apparatus according to any prior embodiment, further comprising a sensor configured to sense at least one of a concentration of the gas component or a concentration of selected components of the gas mixture.
Embodiment 10: The apparatus according to any prior embodiment, wherein the sensor is disposed downstream of the contactor assembly of solid sorbent layers.
Embodiment 11: The apparatus according to any prior embodiment, further comprising a gas flow motivator in flow communication with the contactor assembly of solid sorbent layers.
Embodiment 12: The apparatus according to any prior embodiment, wherein the contactor assembly of solid sorbent layers comprises multiple assemblies of solid sorbent layers in parallel with each other.
Embodiment 13: The apparatus according to any prior embodiment, wherein the gas component is carbon dioxide.
Embodiment 14: A method for removing a gas component from a gas mixture, the method comprising obtaining a plurality of solid sorbent layers, each solid sorbent layer having a gas flow channel traversing the solid sorbent layer, stacking the plurality of solid sorbent layers in series to provide a contactor assembly of solid sorbent layers, and flowing the gas mixture through the contactor assembly of solid sorbent layers to remove the selected gas component from the gas mixture.
Embodiment 15: The method according to any prior embodiment, further comprising rotating at least one of the solid sorbent layers in the contractor assembly of solid sorbent layers to optimize a rate of removal of the gas component or to obtain a selected rate of removal of the gas component.
Embodiment 16: The method according to any prior embodiment, wherein the stacking comprises stacking the plurality of solid sorbent layers in series in a housing.
Embodiment 17: A method for fabricating a monolithic layer of solid sorbent, the method comprising obtaining a mold having a desired outer shape, the mold comprising one or more channel formers, filling the mold with solid sorbent material using a blend melting process, and removing the solid sorbent material from the mold after it solidifies to provide the monolithic layer of solid sorbent.
Embodiment 18: The method according to any prior embodiment, wherein the one or more channel formers extend from one end of the mold to an opposing end of the mold.
Embodiment 19: The method according to any prior embodiment, wherein the mold further comprises one of more alignment feature formers.
Embodiment 20: The method according to any prior embodiment, further comprising fabricating the mold by at least one of an additive manufacturing process, a subtractive manufacturing process, or casting process.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured. The term “coupled” relates to being directly coupled or indirectly coupled using an intermediate component.

The flow diagram depicted herein is just an example. There may be many variations to this diagram or the steps (or operations) described therein without departing from the scope of the invention. For example, operations may be performed in another order or other operations may be performed at certain points without changing the specific disclosed sequence of operations with respect to each other. All of these variations are considered a part of the claimed invention.

The disclosure illustratively disclosed herein may be practiced in the absence of any element which is not specifically disclosed herein.

While one or more embodiments have been shown and described, modifications and substitutions may be made thereto without departing from the scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for removing a gas component from a gas mixture, the apparatus comprising:
a plurality of solid sorbent layers stacked in series to provide a contactor assembly of solid sorbent layers receptive to the gas mixture and configured to reversibly adsorb at least a portion of the gas component from the gas mixture, each solid sorbent layer being traversed by at least one gas flow channel.

2. The apparatus according to claim 1, wherein at least one solid sorbent layer in the plurality of solid sorbent layers has a different composition from another solid sorbent layer in the plurality of solid sorbent layers.

3. The apparatus according to claim 1, wherein each of the solid sorbent layers are substantially the same.

4. The apparatus according to claim 1, wherein each solid sorbent layer comprises an alignment feature configured to align each solid sorbent layer in a selected rotational orientation.

5. The apparatus according to claim 3, wherein the plurality of solid sorbent layers is disposed in a housing.

6. The apparatus according to claim 5, wherein the housing comprises an alignment interface configured to interface with the alignment feature of each solid sorbent layer.

7. The apparatus according to claim 6, wherein the alignment interface comprises at least one of a rod or a protrusion.

8. The apparatus according to claim 1, wherein each solid sorbent layer comprises a shape of a disc.

9. The apparatus according to claim 1, further comprising a sensor configured to sense at least one of a concentration of the gas component or a concentration of selected components of the gas mixture.

10. The apparatus according to claim 9, wherein the sensor is disposed downstream of the contactor assembly of solid sorbent layers.

11. The apparatus according to claim 1, further comprising a gas flow motivator in flow communication with the contactor assembly of solid sorbent layers.

12. The apparatus according to claim 1, wherein the contactor assembly of solid sorbent layers comprises multiple assemblies of solid sorbent layers in parallel with each other.

13. The apparatus according to claim 1, wherein the gas component is carbon dioxide.

14. A method for removing a gas component from a gas mixture, the method comprising:
obtaining a plurality of solid sorbent layers, each solid sorbent layer having a gas flow channel traversing the solid sorbent layer;
stacking the plurality of solid sorbent layers in series to provide a contactor assembly of solid sorbent layers; and
flowing the gas mixture through the contactor assembly of solid sorbent layers to remove the selected gas component from the gas mixture.

15. The method according to claim 14, further comprising rotating at least one of the solid sorbent layers in the contractor assembly of solid sorbent layers to optimize a rate of removal of the gas component or to obtain a selected rate of removal of the gas component.

16. The method according to claim 14, wherein the stacking comprises stacking the plurality of solid sorbent layers in series in a housing.

17. A method for fabricating a monolithic layer of solid sorbent, the method comprising:
obtaining a mold having a desired outer shape, the mold comprising one or more channel formers;
filling the mold with solid sorbent material using a blend melting process; and
removing the solid sorbent material from the mold after it solidifies to provide the monolithic layer of solid sorbent.

18. The method according to claim 17, wherein the one or more channel formers extend from one end of the mold to an opposing end of the mold.

19. The method according to claim 17, wherein the mold further comprises one of more alignment feature formers.

20. The method according to claim 17, further comprising fabricating the mold by at least one of an additive manufacturing process, a subtractive manufacturing process, or casting process.
